(19) United States
(12) Patent Application Publication
(10) Pub. No.: US 2017/0074427 A1
(43) Pub. Date: Mar. 16, 2017

(54) FUEL TUBE FOR A GASOLINE ENGINE

(71) Applicant: Cooper-Standard Automotive, Inc., Novi, MI (US)

(72) Inventors: Andrew ROSENBERG, Almont, MI (US); David BENSKO, Oscoda, MI (US)

(21) Appl. No.: 14/855,541

(22) Filed: Sep. 16, 2015

(51) Int. Cl. F16L 11/04

(52) U.S. Cl. CPC F16L 11/04

(57) ABSTRACT

A fuel tube for a gasoline engine includes an outer polymer layer of polyamide, an inner polymer layer of polyamide, and an intermediate permeation barrier layer of ethylene vinyl alcohol copolymer (EVOH). The permeation barrier layer has an ethylene content of approximately 24 to 29 mol percent and a thickness between approximately 0.02 mm and 0.07 mm.

### FIELD

The present disclosure relates generally to a fuel tube for a gasoline engine. The present disclosure more particularly relates to fuel tube for a gasoline engine having an ethylene vinyl alcohol copolymer (EVOH) layer.

### BACKGROUND

This section merely provides background information related to the present disclosure and may not constitute prior art.

Various fuel tubes are used in automotive and other gasoline engine applications for transferring liquid fuel or fuel vapor. A layer of ethylene vinyl alcohol copolymer (EVOH) is typically used with polymer tubes to provide a hydrocarbon barrier. For example, U.S. Publication No. 2005-0221040 A1 describes a two and three-layered constructions of fuel tubes including a layer of EVOH. The EVOH has a thickness of 0.2 mm to 0.3 mm. EVOH is a relatively brittle material utilized solely for its permeation characteristics.

While known gasoline engine fuel tubes for transferring liquid fuel and fuel vapor may have proven to be generally suitable for their intended purposes, some fuel tubes have had splitting issues. Many manufacturing techniques have been employed to contain this issue.

A continuous need for improvement exists in the relative art.

### SUMMARY

This section provides a general summary of the disclosure, and is not a comprehensive disclosure of its full scope or all of its features.

In accordance with one particular aspect, the present teachings provide a fuel tube for a gasoline engine. The fuel tube includes an outer layer, an inner layer and an intermediate layer. The outer polymer layer may be constructed of a first polyamide selected from a first group consisting of polyamide 12, polyamide 11, polyamide 10-10, polyamide 6-10, polyamide 6-12, polyamide 12-12, and combinations thereof. The inner polymer layer may be constructed of a second polyamide selected from a second group consisting of polyamide 6-10, polyamide 6-12, polyamide 10-10, and combinations thereof. The intermediate layer may be permeation barrier layer constructed of ethylene vinyl alcohol copolymer (EVOH) having an ethylene content of approximately 24 to 29 mol percent and a thickness between approximately 0.02 mm and 0.07 mm.

In accordance with another particular aspect, the present teachings provide a fuel tube for a gasoline engine. The fuel tube includes an outer polymer layer, an inner polymer layer, and an intermediate layer of ethylene vinyl alcohol copolymer (EVOH). The intermediate layer is a permeation barrier layer having an ethylene content of approximately 24 to 29 mol percent and a thickness between approximately 0.02 mm and 0.07 mm.

In accordance with yet another particular aspect, the present teachings provide a fuel tube for a gasoline engine, having an outer polyamide layer, an inner polyamide layer, an intermediate layer of ethylene vinyl alcohol copolymer (EVOH), a first adhesive layer between the inner layer and the intermediate layer, and a second adhesive layer between the outer layer and the intermediate layer. The intermediate layer is a permeation barrier layer having an ethylene content of approximately 24 to 29 mol percent and a thickness between approximately 0.02 mm and 0.07 mm.

Further areas of applicability will become apparent from the description provided herein. The description and specific examples in this summary are intended for purposes of illustration only and are not intended to limit the scope of the present disclosure.

### DRAWINGS

The present teachings will become more fully understood from the detailed description, any appended claims and the following drawings. The drawings are for illustrative purposes only and are not intended to limit the scope of the present disclosure.

FIG. 1 is a perspective view of a fuel tube in accordance with the present teachings.

FIG. 2 is a cross-sectional view of the fuel tube of FIG. 1.

FIG. 3 is a cross-sectional view of another fuel tube in accordance with the present teachings.

FIG. 4 is a cross-sectional view of another fuel tube in accordance with the present teachings.

Corresponding reference numerals indicate corresponding parts throughout the several views of the drawings.

### DESCRIPTION OF VARIOUS ASPECTS

The following description is merely exemplary in nature and is not intended to limit the present disclosure, its application, or uses. It should be understood that throughout the drawings, corresponding reference numerals indicate like or corresponding parts and features.

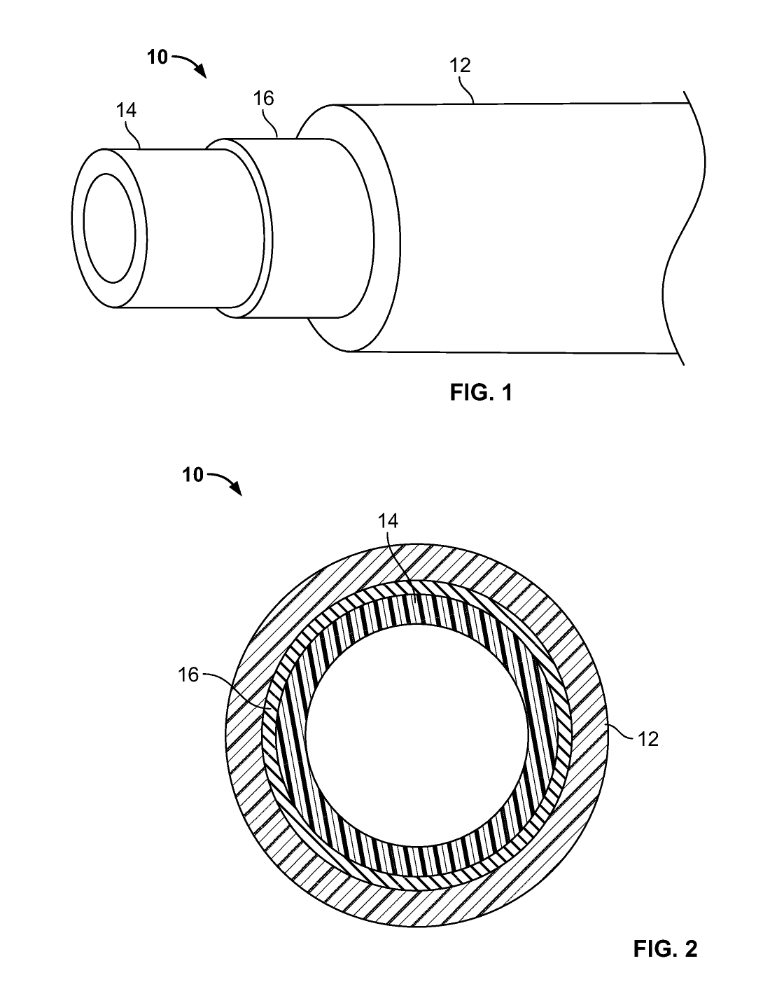

With general reference to FIGS. 1 and 2 of the drawings, a fuel tube for a gasoline engine in accordance with the present disclosure is shown and generally identified at reference character 10. In the embodiment of FIGS. 1 and 2, the fuel tube 10 has a three layer construction including an outer polymer layer 12 and inner polymer layer 14 and an intermediate layer 16. The layers of the fuel tube 10 may be co-extruded in a known manner. It will be understood that the fuel tube may be used in automotive or other gasoline engine applications for transferring liquid fuel or fuel vapor.

In certain embodiments, an outer diameter (OD) of the fuel tube 10 may range from approximately 6.0 mm to 16.0 mm. A wall thickness of the fuel tube may range from approximately 1.0 mm to 1.8 mm. It will be appreciate that these dimensions and other dimensions set forth herein may be modified for particular applications within the scope of the present teachings.

The outer layer 12 may be constructed of a first polyamide. The first polyamide may be selected from a group consisting of polyamide 12, polyamide 11, polyamide 10-10, polyamide 6-10, polyamide 6-12, polyamide 12-12 and combinations thereof. The outer polyamide layer 12 may have a thickness of approximately 0.3 mm to 0.9 mm.

The inner layer 14 may be constructed of a second polyamide. The second polyamide may be a low oligomer polyamide The second polyamide may be selected from a second group consisting of polyamide 6-10, polyamide 6-12, polyamide 10-10 and combinations thereof. The inner layer 14 may be an electrically non-conductive, polyamide layer having a thickness of approximately 0.25 mm to 0.8 mm. Alternatively, the inner layer 14 may be an electrically conductive or static dissipative layer having a thickness of approximately 0.10 mm to 0.40 mm. Where the inner layer 14 is electrically conductive or static dissipative, the fuel tube 10 may incorporate an additional layer of polyamide between the intermediate layer 16 and the inner layer 14.

The intermediate layer 16 is a permeation barrier layer of ethylene vinyl alcohol copolymer (EVOH). Typical fuel tubes incorporate an EVOH layer having an ethylene content of approximately 32 mol percent. The EVOH layer 16 of the present disclosure may have an ethylene content of approximately 24 to 29 mol percent. In certain preferred embodiments, the EVOH has an ethylene content of 29 mol percent or less. In other embodiments, the EVOH has an ethylene content of 25 mol percent or less. The EVOH layer may have a thickness of approximately 0.02 mm and 0.07 mm. In certain preferred embodiments, the EVOH layer 16 has a thickness no greater than 0.07 mm. In other embodiments, the EVOH layer has a thickness no greater than 0.05 mm.

According to one specific example, the fuel tube 10 has an outer layer 12 of polyamide 12 having a thickness of 0.50 mm. One suitable polyamide 12 is commercially available from EMS-Chemie Holding AG as Grilamid XE 4076. In this specific example, the fuel tube 10 has an inner layer 14 of polyamide 6-10 with a thickness of 0.45 mm. One suitable polyamide 6-10 is commercially available from EMS-Chemie Holding AG as Grilamid XE 4077. Further, in this specific example, the fuel tube 10 has an intermediate layer 16 of EVOH having an ethylene content of 25 mol percent and a thickness of 0.05 mm. One suitable EVOH is commercially available from Soarus, LLC as Soarnol V2504RB. Representative tube diameters include OD=8.0 mm and ID=6.0 mm; OD=10.0 mm and ID=8.0 mm; OD=12.0 mm and ID=10.0 mm; OD=12.7 mm and ID=10.7 mm; and OD=15.3 mm and ID=12.5 mm.

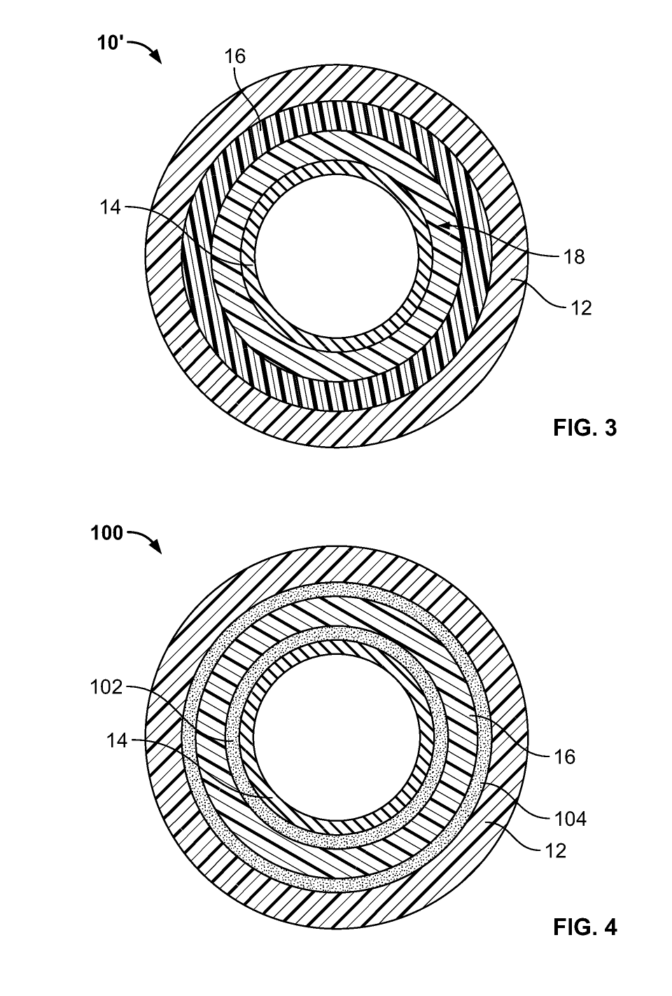

Turning to the cross-sectional view of FIG. 3, an alternative construction of the tube 10 is identified at reference character 10'. In this embodiment, the inner layer 14 is electrically conductive or static dissipative and the tube 10' incorporates an additional layer 18 of polyamide between the intermediate layer 16 and inner layer 14.

Turning to the cross-sectional view of FIG. 4, another fuel tube for a gasoline engine in accordance with the present disclosure is shown and generally identified at reference character 100. In certain applications, it may be desired to incorporate adhesive layers into the fuel tube 10 to adhere the polyamide layers 12 and 14 to the EVOH layer 16. Such adhesive layers are not necessary, however, within the scope of the present disclosure but may be desired depending on the polyamides selected for the inner and outer layers 12 and 14. Given the similarities between the fuel tube 100 and the fuel tube 10, like reference characters have been used in the drawings to identify like elements between the two embodiments.

The fuel tube 100 structurally differs from the fuel tube 10 in that the fuel tube 100 additionally includes first and second adhesive layers 102 and 104. As such, the fuel tube 100 is a five layer fuel tube. The layers of the fuel tube 100 may be co-extruded in a conventional manner. The materials of the inner and outer layers 12 and 14 and the thickness of these layers 12 and 14 may correspond with the corresponding materials and thickness ranges of the fuel tube 10.

According to one specific example, the fuel tube 100 has an outer layer of 12 of polyamide 12 having a thickness of 0.45 mm. One suitable polyamide 12 is commercially available from Arkema as Rilsamid MA4411. In this specific example, the fuel tube 100 has an inner layer 14 of polyamide 6-12 with a thickness of 0.40 mm. One suitable polyamide 6-12 is commercially available from EMS-Chemie Holding AG as Grilamid 2D 25 W20 HLX. Additionally in this specific example, the fuel tube 100 has an intermediate layer 16 of EVOH having an ethylene content of 25 mol percent and a thickness of 0.05 mm. One suitable EVOH is commercially available from Soarus, LLC as Soarnol V2504RB. Further in this specific example, the first and second adhesive layers 102 and 104 are polyamide adhesives. Both adhesive layers 102 and 104 may have a thickness of 0.05 mm. One suitable polyamide adhesive is commercially available from Arkema as Rilsan Tie Flex S 452.

The present teachings have been described in relationship to embodiments having three, four and five layer constructions. It will be appreciated that lesser or additional layers may be utilized within the scope of the present teachings.

It will be appreciated that the present teachings provide a fuel tube having increased robustness and reduced oligomers to help prevent sticking valves and plugged injectors. A reduced thickness of the EVOH layer renders the fuel tube significantly more resistant to splitting or cracking during manufacturing. It was surprisingly discovered that there was a dramatic reduction in splitting due to the reduced thickness of the EVOH layer.

While specific examples have been discussed in the specification and illustrated in the drawings, it will be understood by those skilled in the art that various changes may be made and equivalence may be substituted for elements thereof without departing from the scope of the present teachings. Furthermore, the mixing and matching of features, elements and/or functions between various examples may be expressly contemplated herein so that one skilled in the art would appreciate from the present teachings that features, elements and/or functions of one example may be incorporated into another example as appropriate, unless discussed otherwise above. Moreover, many modifications may be made to adapt a particular situation or material to the present teachings without departing from the essential scope thereof. Therefore, it may be intended that the present teachings not be limited to the particular examples illustrated by the drawings and discussed in the specification as the best mode of presently contemplated for carrying out the present teachings but that the scope of the present disclosure will include any embodiments following within the foregoing description and any appended claims.

What is claimed is:

1. A fuel tube for a gasoline engine, the fuel tube comprising:
an outer polymer layer;
an inner polymer layer; and
an intermediate layer of ethylene vinyl alcohol copolymer (EVOH),
wherein the intermediate layer is a permeation barrier layer having an ethylene content of approximately 24 to 29 mol percent and a thickness between approximately 0.02 mm and 0.07 mm.

2. The fuel tube for a gasoline engine of claim 1, wherein the outer polymer layer is constructed of polyamide.

3. The fuel tube for a gasoline engine of claim 1, wherein the outer polymer layer is constructed of a polyamide selected from a group consisting of polyamide 12, polyamide 11, polyamide 10-10, polyamide 6-10, polyamide 6-12, polyamide 12-12 and combinations thereof.

4. The fuel tube for a gasoline engine of claim 6, wherein the inner polymer layer is constructed of a low oligomer polyamide selected from a group consisting of polyamide 6-10, polyamide 6-12, polyamide 10-10 and combinations thereof.

5. The fuel tube for a gasoline engine of claim 1, wherein the outer polymer layer is constructed of a polyamide selected from a first group consisting of polyamide 12, polyamide 11, polyamide 10-10, polyamide 6-10, polyamide 6-12, polyamide 12-12 and combinations thereof and the inner polymer layer is constructed of a polyamide selected from a second group consisting of polyamide 6-10, polyamide 6-12, polyamide 10-10 and combinations thereof.

6. The fuel tube for a gasoline engine of claim 1, wherein the fuel tube is three-layer, co-extruded tube.

7. The fuel tube for a gasoline engine of claim 1, wherein the fuel tube is a liquid fuel tube for transferring a liquid fuel.

8. The fuel tube for a gasoline engine of claim 1, wherein the fuel tube is a fuel vapor tube for transferring a fuel vapor.

9. The fuel tube for a gasoline engine of claim 1, wherein the inner layer is a conductive layer or a static dissipative layer.

10. The fuel tube for a gasoline engine of claim 1, wherein the inner layer is a non-conductive layer.

11. The fuel tube for a gasoline engine of claim 1, wherein the inner layer is a low oligomer polyamide layer.

12. The fuel tube for a gasoline engine of claim 9, further comprising a further layer of polyamide disposed between the conductive layer and the intermediate layer.

13. The fuel tube for a gasoline engine of claim 1, further comprising at least a first adhesive layer between the intermediate layer and one of the inner and outer polymer layers.

14. The fuel tube for a gasoline engine of claim 1, further comprising a first adhesive layer between the inner layer and the intermediate layer and a second adhesive layer between the outer layer and the intermediate layer.

15. The fuel tube for a gasoline engine of claim 14, wherein the fuel tube is a five-layer, co-extruded tube.

16. A fuel tube for a gasoline engine, the fuel tube comprising:
an outer polyamide layer;
an inner polyamide layer;
an intermediate layer of ethylene vinyl alcohol copolymer (EVOH);
a first adhesive layer between the inner layer and the intermediate layer; and
a second adhesive layer between the outer layer and the intermediate layer,
wherein the intermediate layer is a permeation barrier layer having an ethylene content of approximately 24 to 29 mol percent and a thickness between approximately 0.02 and 0.07 mm.

17. A fuel tube for a gasoline engine of claim 16, wherein the outer polymer layer is constructed of a polyamide selected from a group consisting of polyamide 12, polyamide 11, polyamide 10-10, polyamide 6-10, polyamide 6-12, polyamide 12-12 and combinations thereof.

18. The fuel tube for a gasoline engine of claim 16, wherein the inner polymer layer is constructed of a low oligomer polyamide selected from a group consisting of polyamide 6-10, polyamide 6-12, polyamide 10-10 and combinations thereof.

19. The fuel tube for a gasoline engine of claim 16, wherein the outer polymer layer is constructed of a polyamide selected from a first group consisting of polyamide 12, polyamide 11, polyamide 10-10, polyamide 6-10, polyamide 6-12, polyamide 12-12 and combinations thereof and the inner polymer layer is constructed of a polyamide selected from a second group consisting of polyamide 6-10, polyamide 6-12, polyamide 10-10 and combinations thereof.

20. The fuel tube for a gasoline engine of claim 16, wherein the inner layer is a conductive layer or a static dissipative layer, and
further comprising a further layer of polyamide disposed between the conductive layer and the intermediate layer,
wherein the further layer of polyamide may replace the first adhesive.
